(19) United States
(12) Patent Application Publication
(10) Pub. No.: US 2012/0146537 A1
(43) Pub. Date: Jun. 14, 2012

(54) VARIABLE-INDUCTOR ELECTRONIC BALLASTS

(76) Inventor: Sheng-Hann Lee, Saratoga, CA (US)

(21) Appl. No.: 12/963,576

(22) Filed: Dec. 8, 2010

(51) Int. Cl. H05B 41/36

(52) U.S. Cl. 315/291

(57) ABSTRACT

A variable-inductor electronic ballast includes a generic ballast and a variable-inductor controller. The variable-inductor controller includes either an additive-inductor or a subtractive-capacitor embodiment. An optional winding to the existing transformer can enhance the ratio of power steps.

### BACKGROUND OF THE INVENTION

1. Field of the Invention

The present invention relates to electronic ballasts with step-dimming capability. More specifically, a variable-inductor controller is built onto an existing electronic ballast to adjust fluorescent lamp power by changing ballast inductance.

2. Description of the Prior Art

At the heart of a compact fluorescent lamp (CFL) generally resides a self-oscillating, half-bridge electronic ballast (hereinafter generic electronic ballast) for driving a fluorescent tube (also known as a gas discharge tube). FIG. 1 is a schematic diagram of a CFL 10 with a tube 11 terminated to a node B (ground). In spite of variations in the termination, rectification, resonance tank, preheat, and EMI, etc., all self-oscillating, half-bridge ballasts can be reduced to what is shown in FIG. 1 in the operating principle.

In operation, capacitor C2 is charged up after power-up, causing DIAC U1 to fire through transistor Q1. Saturating transformer T1 has triple windings T1-1, T1-2, T1-3 to provide positive feedback signals driving transistor Q1 and transistor Q2 alternately. Saturating characteristics of transformer T1 along with reverse recovery time of the transistors Q1, Q2 determine conduction time of transistors Q1 and Q2. Diode D7 disables DIAC U1 after a successful startup. Inductor L1 and capacitor C4 form a series resonance to boost signal voltage at the tube. Capacitor C5 is a direct current (dc) blocking capacitor. Resistor R4 sets up the startup condition properly. Capacitor C3 adjusts the slew rate to minimize the switching loss. The inverter outputs square-wave signals at node A to drive complex load branch impedance Z, which sets lamp power in the burn phase.

The generic electronic ballast 10 has the advantages of compact design and low cost, and combined with a fluorescent tube forms a self-contained fluorescent lamp, commonly known as a basic CFL. However, such fluorescent lamps face a challenge, namely dimming, or the ability to lower brightness of a lamp, because the lamp operates with a fixed ballast inductor at a constant frequency. Therefore, the generic electronic ballast does not having dimming capability.

On the other hand, there are limited electronic ballasts incorporating an IC controller so that the operating frequency can be programmed in the burn phase for the purpose of dimming. Such electronic ballasts require expensive NMOS switches to minimize the load to the IC controller and to extend the operating frequency range that is needed for dimming, and the IC controller is also a complex power management system. The lamp is dimmable but expensive, making it unpopular in the cost-sensitive lighting market.

### SUMMARY OF THE INVENTION

According to an embodiment, a fluorescent lamp comprises a fluorescent tube, and a variable-inductor electronic ballast for adjusting power of the fluorescent lamp.

According to an embodiment, a variable-inductor controller for use in a fluorescent lamp comprises an inductance tuning module, and a switching module for selectively enabling series electrical connection between the inductance tuning module and a fluorescent tube of the fluorescent lamp for providing ballast inductance tuning for fluorescent lamp power adjustment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a basic CFL with self-oscillating, half-bridge electronic ballast according to the prior art.

FIG. 2A is a diagram of a load branch of the basic CFL of FIG. 1 with a fixed inductor.

FIG. 2B is a diagram of a load branch with an additive inductor.

FIG. 2C is a diagram of a load branch with a subtractive capacitor.

FIG. 3 is a diagram of a variable-inductor electronic ballast according to the first embodiment of the present invention.

FIG. 4 is a diagram of a variable-inductor electronic ballast according to the second embodiment of the present invention.

FIG. 5 is a diagram of a first embodiment of the variable-inductor controller of FIG. 3 and FIG. 4.

FIG. 6 is a diagram of a second embodiment of the variable-inductor controller.

FIG. 7 is a diagram of a third embodiment of the variable-inductor controller with enhanced power ratio.

FIG. 8 is a diagram of a fourth embodiment of the variable-inductor controller with enhanced power ratio.

FIG. 9 is a diagram of a variable-inductor electronic ballast according to the third embodiment of the present invention.

FIG. 10 is a diagram of a variable-inductor electronic ballast according to the fourth embodiment of the present invention.

### DETAILED DESCRIPTION

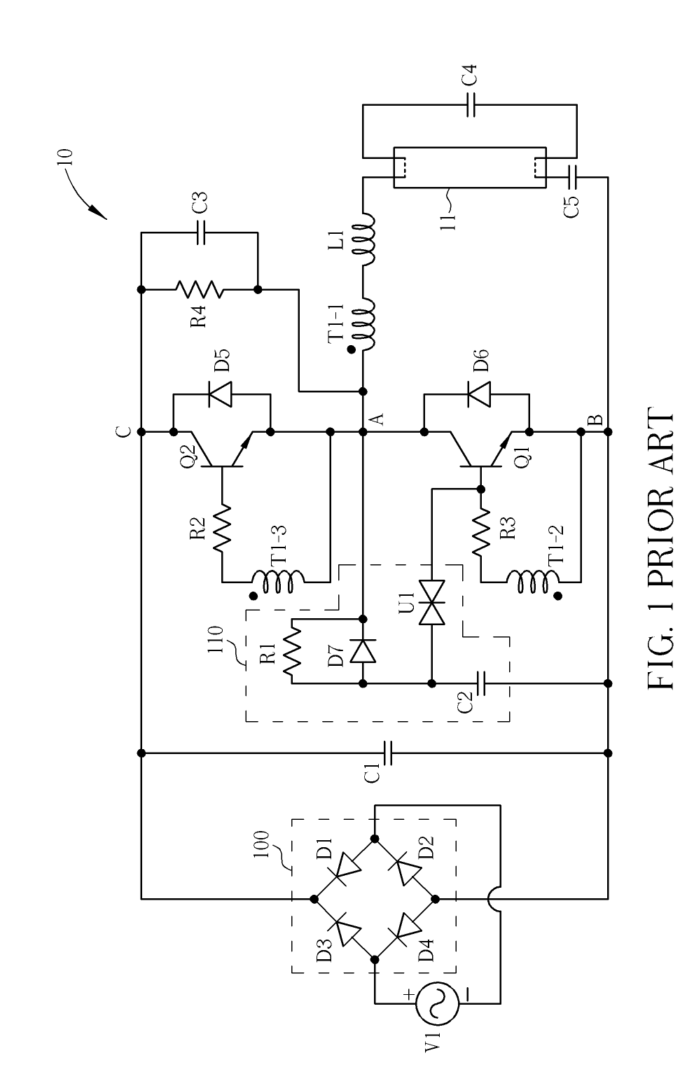

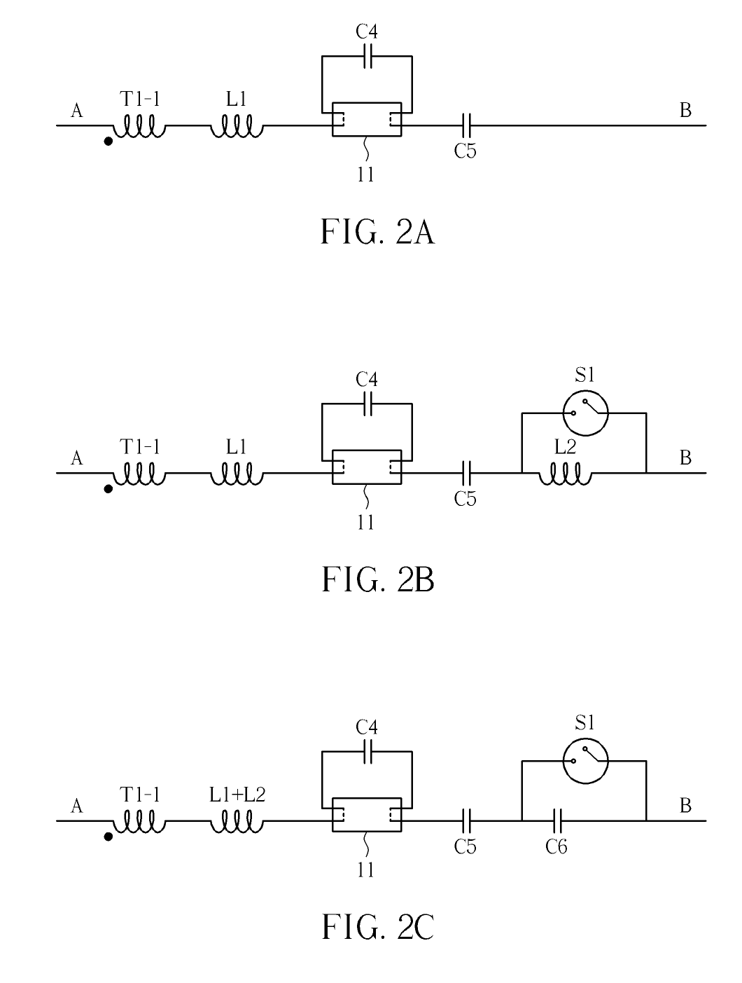

The load branch between nodes A and B in FIG. 1 is highlighted in FIG. 2A for discussion. A capacitor C5 is a direct current (dc) blocking capacitor. For a self-oscillating, half-bridge inverter, operating frequency F thereof is primarily determined by inductor L1 and capacitor C4, though further modified by impedance of tube 11, characteristics of transformer T1, and reverse recovery time of transistors Q1 and Q2. Since square-wave signals outputted at node A are of constant amplitude, tube power is determined by impedance Z at the operating frequency F.

Please refer to FIG. 2B, where an additive-inductor L2 is in series with inductor L1 for increased ballast inductance when switch S1 is in open position. For purposes of illustration, the additive-inductor L2 in FIG. 2B is electrically connected between the capacitor C5 and node B.

The addition of the additive-inductor L2 to the load branch brings the operating frequency F down to:

F≈1/{2π*√[(L1+L2)*C4]}. (1)

The impedance Z of the ballast inductor increases to:

Z≈√[(L1+L2)/C4]. (2)

It can be seen from equation (2) that current through the ballast inductor decreases when the additive-inductor L2 is included in the load branch, which decreases lamp power, and hence lamp brightness.

When switch S1 is closed, total inductance reverts to L1, returning the operating frequency F and the impedance Z to that of the load branch shown in FIG. 2A. With two different ballast inductances, the lamp power assumes two distinct power levels, and by extension two different brightness levels.

Based on a similar principle, FIG. 2C shows a subtractive-capacitor C6 added to the load branch of FIG. 2A to cause a series resonance with a second inductor L2 at the operating frequency F, resulting in inductor L1 in the load branch alone. The subtractive-capacitor C6 may be designed to approximately cancel out impedance of the second inductor L2 at the operating frequency F, i.e., a tuning capacitor. Switch S1 is connected across capacitor C6. When switch S1 closes, the series resonance between capacitor C6 and inductor L2 is removed, leaving both inductors L1, L2 intact. Using the two inductor values (L1 and L1+L2) provided by the load branch shown in FIG. 2C, the lamp power becomes adjustable as in the case of additive-inductor electronic ballast. In practice, inductor L1 and second inductor L2 may be combined in a single inductor to realize cost savings in FIG. 2C.

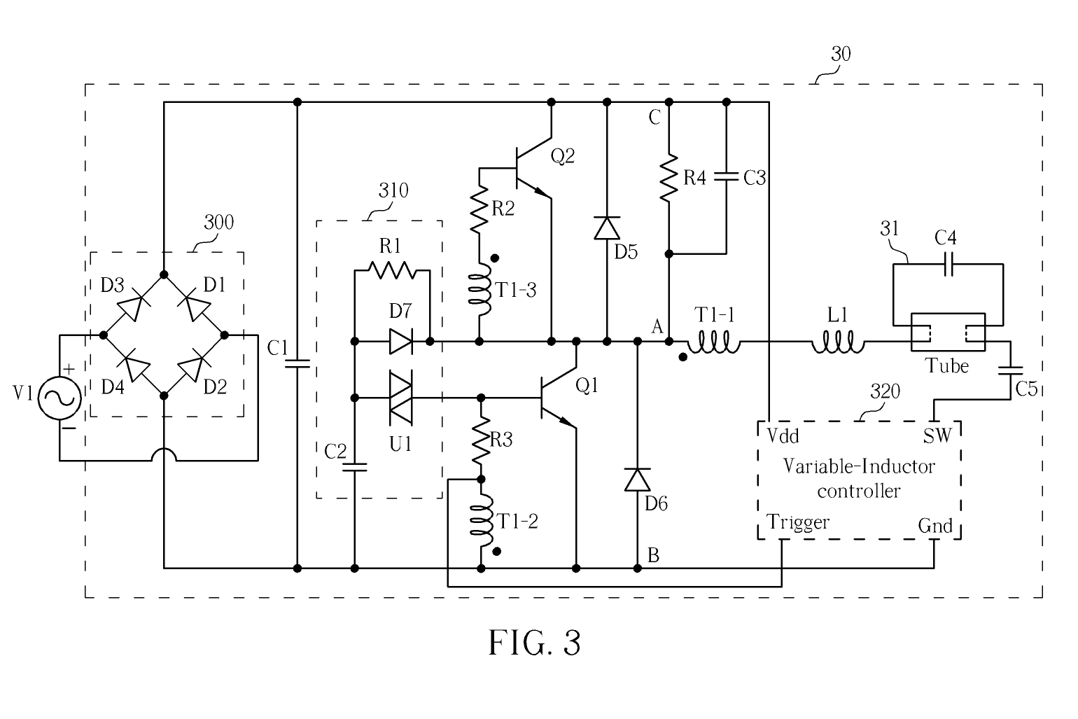

Please refer to FIG. 3, which is a diagram of a variable-inductor electronic ballast providing power tuning capability for a fluorescent tube terminated to node B according to a first embodiment of the present invention. The variable-inductor electronic ballast comprises a generic electronic ballast comprising diodes D1-D7, transistors Q1-Q2, capacitors C1-C5, inductor L1, resistors R1-R4, transformer T1 and DIAC U1, and further comprises a variable-inductor controller 320.

The variable-inductor controller 320 has a power terminal Vdd electrically connected to node C, a trigger terminal Trigger electrically connected to node D (junction of winding T1-2 and resistor R3), a switch terminal SW electrically connected to capacitor C5, and a ground terminal Gnd electrically connected to node B. The variable-inductor controller 320 mimics either the function of FIG. 2B or FIG. 2C to achieve variable ballast inductance. Other than the variable-inductor controller 320, the variable-inductor electronic ballast 30 includes the same components as the generic ballast in FIG. 1.

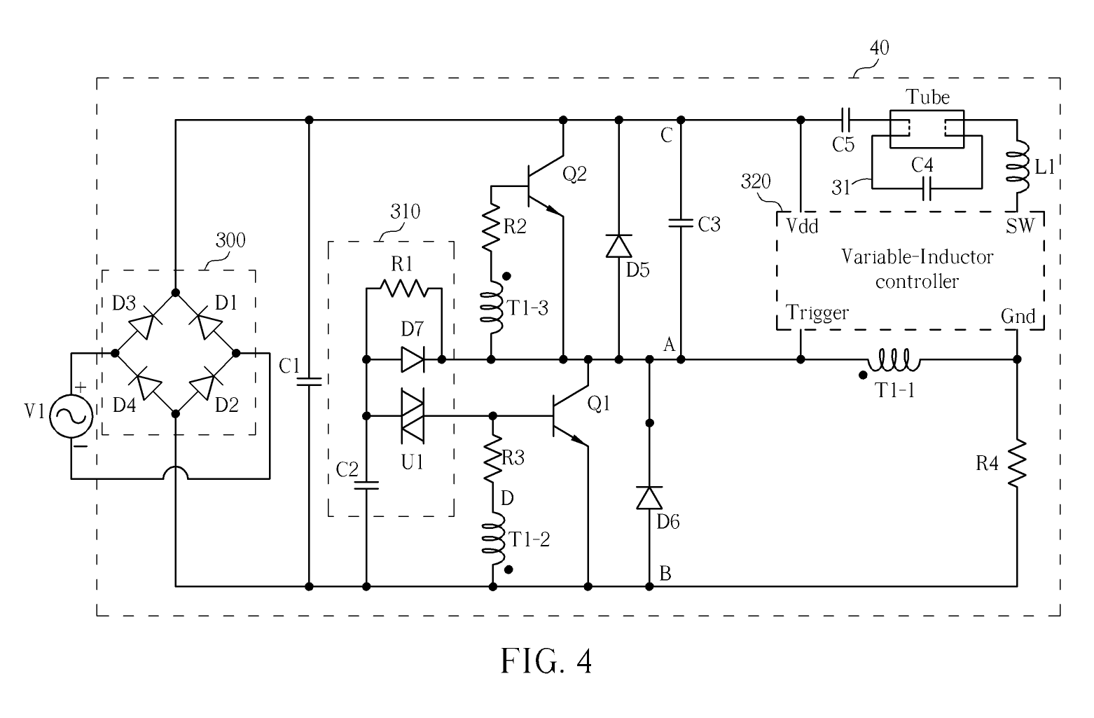

Please refer to FIG. 4, which is a diagram of a variable-inductor electronic ballast 40 providing power tuning capability for a fluorescent tube 11 terminated to node C according to a second embodiment of the present invention. The variable-inductor electronic ballast 40 comprises a generic electronic ballast compromising diodes D1-D7, transistors Q1-Q2, capacitors C1-C5, inductor L1, resistors R1-R4, transformer T1 and DIAC U1, and further comprises the variable-inductor controller 320. Different from the variable-inductor electronic ballast 30 shown in FIG. 3, in the variable-inductor electronic ballast 40, capacitor C5 is electrically connected between tube 11 and node C, and inductor L1 is electrically connected between tube 11 and the switch terminal SW of the variable-inductor controller 320. Further, the trigger terminal Trigger of the variable-inductor controller 320 is electrically connected to node A, and the ground terminal Gnd is electrically connected to winding T1-1. Resistor R4 is relocated to a position between node B and the junction of winding T1-1 and the ground terminal Gnd of the variable-inductor controller 320 to complete a dc loop, ensuring the variable-inductor controller 320 is powered up before DIAC U1 fires up the electronic ballast. The variable-inductor controller 320 mimics the function of either FIG. 2B or FIG. 2C to achieve variable ballast inductance. Other than the variable-inductor controller 320, and the connections mentioned above, the electronic ballast shares the same components and interconnections described above for the generic ballast shown in FIG. 1.

In addition to the embodiment shown in FIG. 4, the fluorescent tube 11 may also be terminated to a center tap of two series connected capacitors between node B and node C. For example, an optional capacitor may be electrically connected between node B and the junction of the fluorescent tube 11 and the capacitor C5 shown in FIG. 4. As a result, the fluorescent tube 11 is terminated to the center tap between the optional capacitor and the respective capacitor C5.

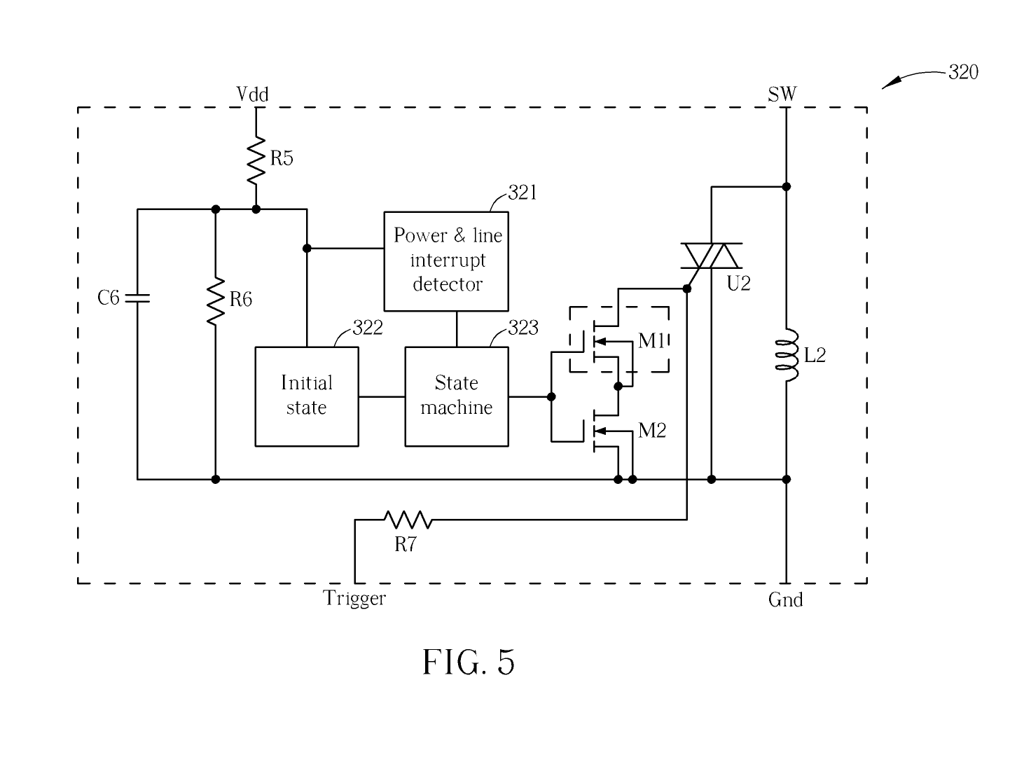

Please refer to FIG. 5, which is a diagram of the variable-inductor controller 320 in a first embodiment. The variable-inductor controller 320 comprises three functional blocks: a power and interrupt detector 321, an initial state module 322, and a state machine 323. The variable-inductor controller 320 further comprises resistors R5-R7, capacitor C6, inductor L2, isolated NMOS M1, NMOS M2, and TRIAC U2. Resistor R5 is electrically connected between the power terminal Vdd and an input terminal of the power and interrupt detector 321. Resistor R6 is electrically connected between the input terminal of the power and interrupt detector 321 and the ground terminal Gnd. Resistors R5 and R6 form a voltage divider to power the variable-inductor controller 320. Capacitor C6 is electrically connected between the input terminal of the power and interrupt detector 321 and the ground terminal Gnd (in parallel with resistor R6, also known as the lower branch of the divider), and filters out power supply noise. TRIAC U2 and inductor L2 are electrically connected in parallel between the switch terminal SW and the ground terminal Gnd. Resistor R7 is electrically connected between the junction of the gate of TRIAC U2 and state machine module 323 and the trigger terminal Trigger. The initial state module 322 ensures the variable-inductor controller 320 always starts from a designated state after being off longer than a predefined time interval. The power and interrupt detector 321 manages the controller dc supply and extracts an input signal from the power supply when the off time is shorter than the predefined time interval. The state machine 323 uses a shunt switch to bypass the trigger signal from transformer T1 (either from winding T1-2 in FIG. 3, or from winding T1-1 in FIG. 4) to Main Terminal 1 (MT1) of TRIAC U2 before it reaches the gate of TRIAC U2 according to predefined conditions. The shunt switch comprises an isolated NMOS M1 and an NMOS M2 in cascode, with the gates tied together. The resulting switch exhibits two stacked body diodes in the off state to present an open-circuit condition to the gate of TRIAC U2, which resembles a single diode junction. Additional isolated NMOS transistors may be included if more stacked body diodes are required. As a result, good trigger sensitivity is maintained from two-quadrant triggering.

Moreover, the variable-inductor controller 320 also includes an additive-inductor L2, and the TRIAC U2. Additive-inductor L2 causes the lamp power to decrease as described above. TRIAC U2 is selected as the switch because it can block high alternating current (ac) voltages in the off state. The trigger signal is also supplied by transformer T1 through the shunt control of the state machine 323 because input characteristics of TRIAC U2 are similar to those of transistors Q1 and Q2. TRIAC U2 latches up inherently, because the operating frequency F exceeds a turn-off limit of the TRIAC U2, turning a device limitation into an advantage.

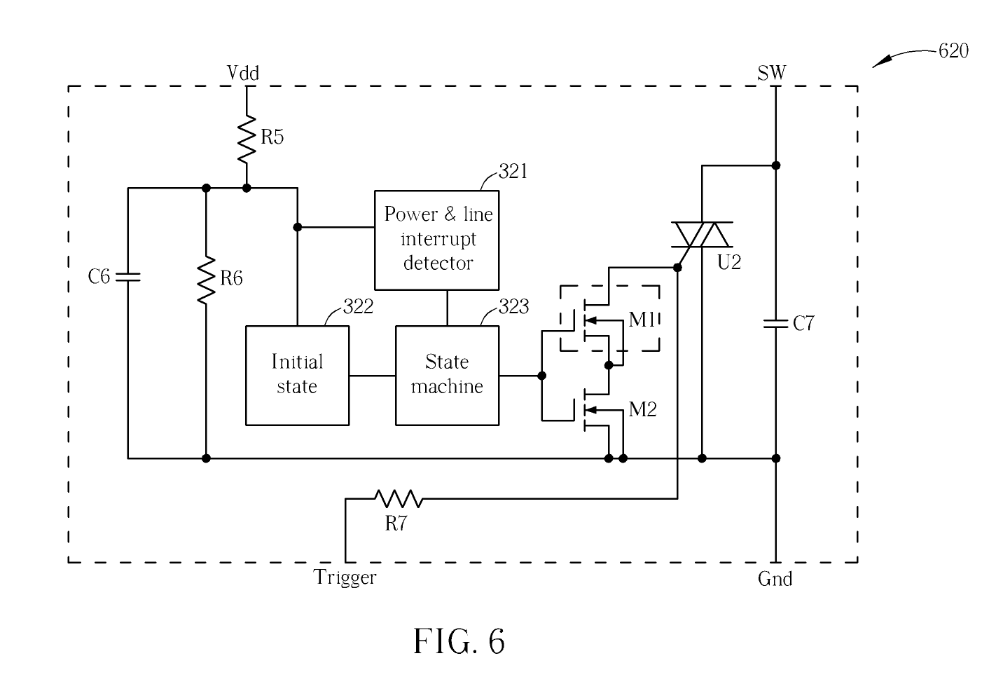

Please refer to FIG. 6, which is a diagram of a second embodiment of the variable-inductor controller 620. Components of the variable-inductor controller 620 shown in FIG. 6 having the same reference numerals as those shown in FIG. 5 have similar or the same structure and function as those shown in FIG. 5. The embodiment of the variable-inductor controller 620 shown in FIG. 6 does not include the additive-inductor L2, and further comprises a subtractive-capacitor C7. Capacitor C7 is electrically connected between the switch terminal SW and the ground terminal Gnd (in parallel with the TRIAC U2), and causes the lamp power to increase. Please note that switching modes of the variable-inductor controller 620 are opposite those described for the variable-inductor controller 320 shown in FIG. 5. In FIG. 6, to lower lamp power, the TRIAC U2 is turned on to short out the subtractive-capacitor C7. In FIG. 5, to lower lamp power, the TRIAC U2 is turned off to include the additive-inductor L2.

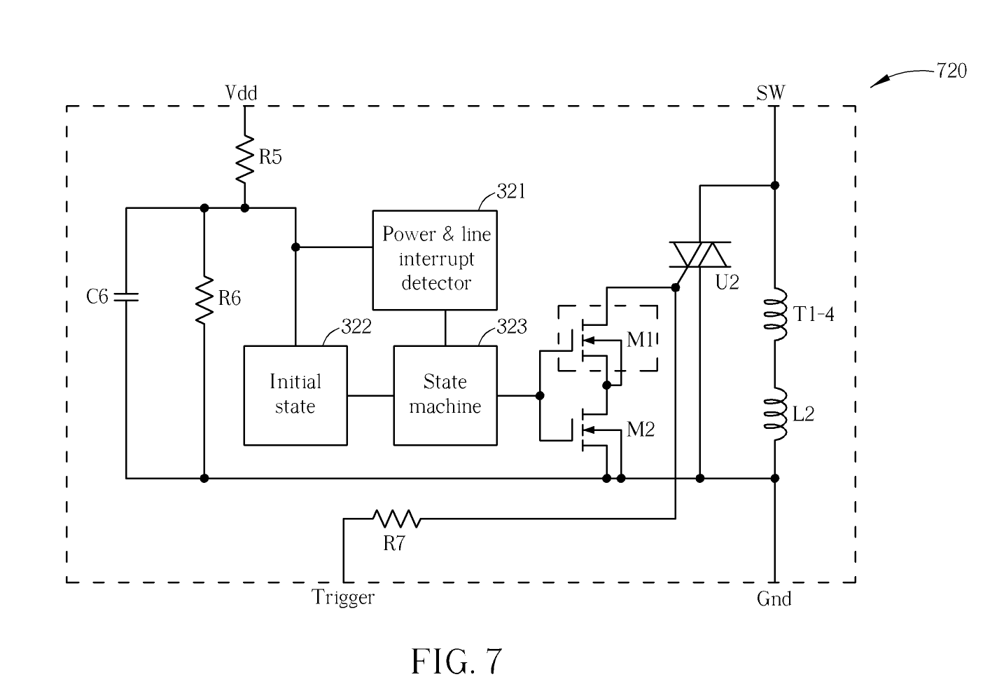

Please refer to FIG. 7, which is a diagram of a third embodiment of the variable-inductor controller 720 having enhanced power ratio. The variable-inductor controller 720 shown in FIG. 7 is similar to the variable-inductor controller 320 shown in FIG. 5, and further comprises an optional fourth winding T1-4 in series with inductor L2. As shown in FIG. 7, the optional fourth winding T1-4 may be electrically connected between the switch terminal SW and the additive-inductor L2. Since transformer T1 is optimized for high power originally, additional winding T1-4 injects extra current to re-optimize transformer T1 for low power. The winding T1-4 is in series with inductor L2 in low power, and is taken out by TRIAC U2 in high power. When the polarity of winding T1-4 is out of phase with the polarity of winding T1-1, the injected current decreases core saturation, creating the same effect as decreasing the number of turns of winding T1-1, and cuts back the lamp power further.

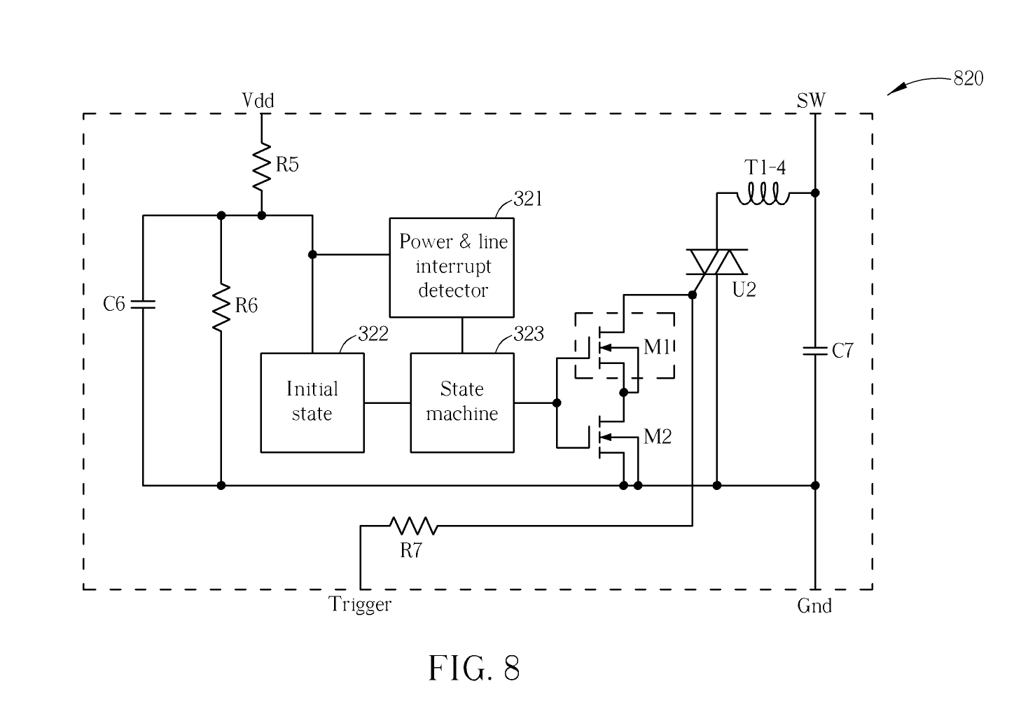

Please refer to FIG. 8, which is a diagram of a fourth embodiment of the variable-inductor controller 820 having enhanced power ratio. The variable-inductor controller 820 shown in FIG. 8 is similar to the variable-inductor controller 620 shown in FIG. 6, and further comprises an optional fourth winding T1-4 in series with TRIAC U2. As shown in FIG. 8, the optional fourth winding T1-4 may be electrically connected between the TRIAC U2 and the switch terminal SW. Since transformer T1 is optimized for high power, additional winding T1-4 injects extra current to re-optimize transformer T1 for low power. Again, the winding T1-4 is inside the low power loop only by the control of TRIAC U2. When the polarity of winding T1-4 is out of phase with the polarity of winding T1-1, the injected current decreases core saturation, creating the same effect as decreasing the number of turns of winding T1-1, and cuts back the lamp power further.

The variable-inductor controllers 720, 820 shown in FIG. 7 and FIG. 8 further comprise the optional fourth winding T1-4 configured to inject current to decrease core saturation in low-power operation. By reconfiguring the winding T1-4 to be placed inside the high power loop, and reversing the polarity of the winding T1-4 to be in phase with the polarity of the winding T1-1, the winding T1-4 may increase core saturation in high-power operation, enhancing the lamp power, presuming transformer T1 has been optimized for low-power operation. In the embodiment shown in FIG. 7, the optional fourth winding T1-4 may be electrically connected between the switch terminal SW and the MT2 (Main Terminal 2) of the TRIAC U2 to achieve the described effect. In the embodiment shown in FIG. 8, the optional fourth winding T1-4 may be electrically connected between the switch terminal SW and the subtractive-capacitor C7 to achieve the described effect.

In the above, TRIAC U2 is controlled by a control signal, which may originate from power and interrupt detector 321, from an occupancy detector, such as an infrared detector or an ultrasound detector for energy savings dimming, and/or from a photo detector for ambient light compensation. TRIAC U2 acts as a switching module that provides auto-switching in the variable-inductor controllers described above. For manual switching, a mechanical switch may be used as the switching module, as well.

The embodiments described so far minimize alterations to the original ballast. However, for tubes requiring high sustaining voltage, such as high-power lamps, signal detection and DIAC triggering prefer connections to the ac mains over dc voltage rail. Connections to the ac mains are preferred because dc voltage rail usually retains high voltage after a high-power lamp is turned off, which could either cause a detection error due to reduced voltage range, or fire up the ballast before the variable-inductor controller is powered up, causing a triggering error, because TRIAC U2 will be triggered by the ballast autonomously if the variable-inductor controller does not place it under control.

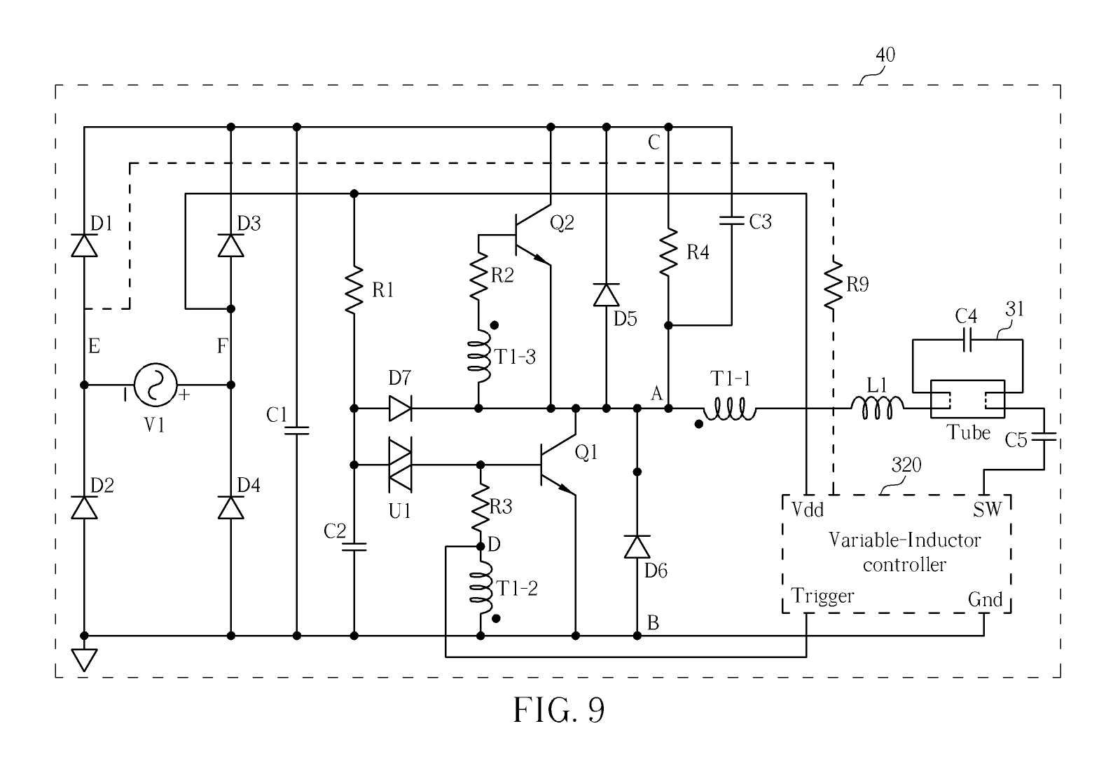

Please refer to FIG. 9, which is similar to FIG. 3, except that one end of resistor R1 and power terminal Vdd of the variable-inductor controller 320 are moved from node C to a node F according to a third embodiment of the present invention. Node F has zero floor voltage after the lamp is powered down, which helps signal detection. Node F also outputs half-rectified mains voltage to increase charge time of resistor R1 and capacitor C2, adding to the delay of DIAC U1 firing. For even better detection, a resistor R9 can be connected between a node E and the junction of resistors R5 and R6 inside the variable-inductor controller 320, which provides full-rectified mains voltage to suppress mains ripple voltage further.

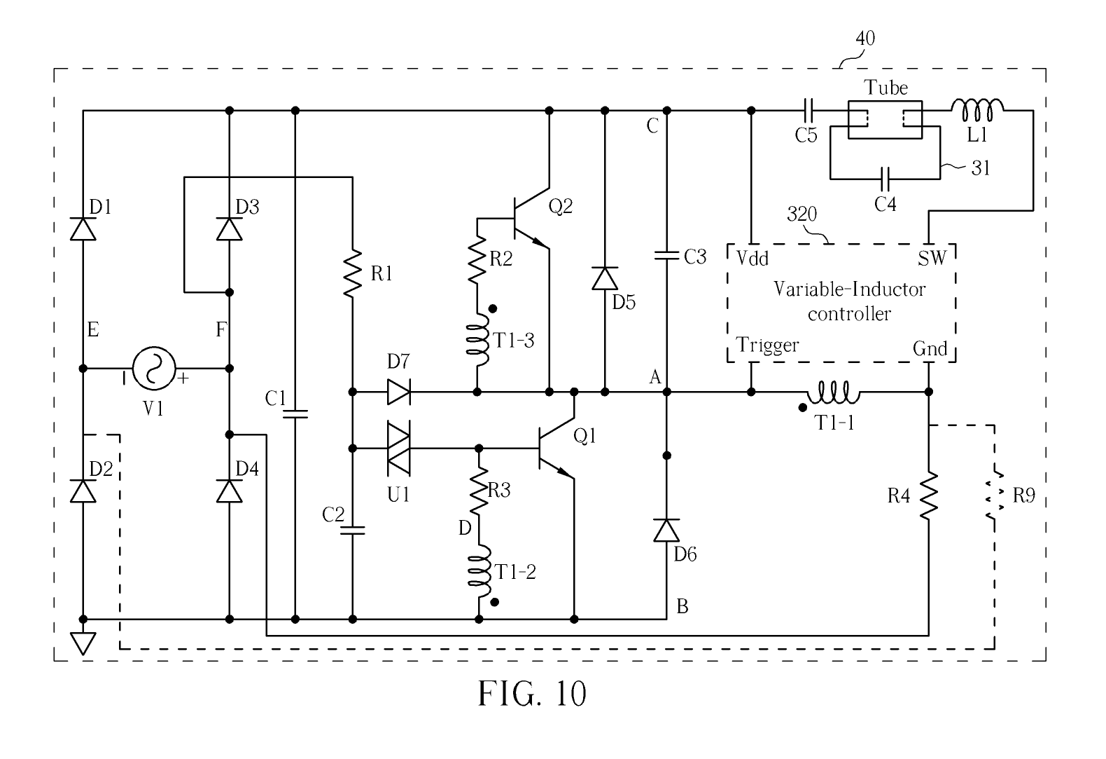

Please refer to FIG. 10, which is similar to FIG. 4, except that one end of resistor R1 and one end of resistor R4 are moved from node C and node B, respectively, to a node F according to a fourth embodiment of the present invention. For even better detection, a resistor R9 can be connected between a node E and the junction of resistor R4, a winding of transformer T1 and the ground terminal of the variable-inductor controller 320, which provides full-rectified mains voltage to suppress mains ripple voltage further. The changes are based on a similar principle to that illustrated in FIG. 9.

In some rare cases, the self-oscillating, half-bridge electronic ballasts adopt NMOS transistors as the switches with transformer T1 changed to a linear core. The variable-inductor controller concept is still applicable because it is an independent device doing parallel processing to the main ballast.

The electronic ballasts described above provide dimming functionality while enjoying the size and cost advantages of the generic self-oscillating, half-bridge electronic ballast. The electronic ballasts enable makers of CFLs to deploy products more rapidly, and benefit users of CFLs with additional power savings at a fractional cost.

Those skilled in the art will readily observe that numerous modifications and alterations of the device and method may be made while retaining the teachings of the invention.

What is claimed is:

1. A fluorescent lamp comprising:
a fluorescent tube; and
a variable-inductor electronic ballast for adjusting power of the fluorescent lamp.

2. The fluorescent lamp of claim 1, wherein the fluorescent tube is terminated to a ground node.

3. The fluorescent lamp of claim 1, wherein the fluorescent tube is terminated to a power supply node.

4. The fluorescent lamp of claim 1, wherein the fluorescent tube is terminated to a center tap of two series connected capacitors between a ground node and a power supply node.

5. The fluorescent lamp of claim 1, wherein the variable-inductor electronic ballast comprises:
a generic electronic ballast comprising a self-oscillating, half-bridge inverter; and
a variable-inductor controller coupled to the generic electronic ballast for adjusting the power.

6. The fluorescent lamp of claim 5, wherein the variable-inductor controller comprises:
a voltage divider circuit electrically connected between a power supply node and a ground node for powering the variable-inductor controller;
a capacitor electrically connected in parallel with the lower branch of the voltage divider circuit for filtering noise;
an initial state module comprising an input terminal electrically connected to an output node of the voltage divider circuit, and an output terminal;
a power and interrupt detector comprising an input terminal electrically connected to the output node of the voltage divider circuit, and an output terminal;
a state machine comprising:
a first input terminal electrically connected to the output terminal of the initial state module;
a second input terminal electrically connected to the output terminal of the power and interrupt detector; and
an output terminal;
an additive-inductor electrically connected in series with the fluorescent tube for providing ballast inductance tuning for fluorescent lamp power adjustment;
a TRIAC electrically connected in parallel with the additive-inductor for selectively shorting out the additive-inductor, wherein a gate terminal of the TRIAC is electrically connected to the output terminal of the state machine and the trigger terminal; and
a shunt control electrically connected to the junction of the output terminal of the state machine and the gate terminal of the TRIAC.

7. The fluorescent lamp of claim 6, wherein the TRIAC is triggered by a signal from a transformer of the generic electronic ballast through a shunt control of the state machine.

8. The fluorescent lamp of claim 7, wherein the shunt control comprises an isolated NMOS and an NMOS in cascode with gates of the isolated NMOS and the cascoded NMOS tied together to exhibit two, or more with additional isolated NMOS, stacked body diodes in the off state.

9. The fluorescent lamp of claim 8, wherein the signal is bypassed to the MT1 of the TRIAC when the cascaded NMOS shunt switch is in the on state.

10. The fluorescent lamp of claim 8, wherein a two-quadrant trigger signal is maintained when the cascoded NMOS shunt switch is in the off state.

11. The fluorescent lamp of claim 7, wherein the signal is fed by a resistor having one end electrically connected to the transformer.

12. The fluorescent lamp of claim 6, wherein a fourth winding of a transformer of the generic electronic ballast is electrically connected in series with the additive-inductor, and polarity of the fourth winding is out of phase with polarity of a first winding of the transformer for additional power attenuation in low-power operation.

13. The fluorescent lamp of claim 6, wherein a fourth winding of a transformer of the generic electronic ballast is electrically connected between main terminal 2 (MT2) of the TRIAC and a switch terminal of the variable-inductor controller, and polarity of the fourth winding is in phase with polarity of a first winding of the transformer for additional power enhancement in high-power operation.

14. The fluorescent lamp of claim 6, wherein the power supply node is an ac mains node having zero floor voltage after the lamp is powered down for helping signal detection.

15. The fluorescent lamp of claim 14, further comprising a resistor electrically connected between the voltage divider circuit and another ac mains node for providing full-rectified mains voltage to suppress mains ripple voltage.

16. The fluorescent lamp of claim 6, wherein the generic ballast comprises a start-up circuit comprising:
a start-up resistor electrically connected to the power supply node;
a start-up capacitor electrically connected between the start-up resistor and the ground node; and
a DIAC electrically connected to a junction of the start-up resistor and the start-up capacitor;
wherein the power supply node outputs half-rectified mains voltage for increasing charge time of the start-up resistor and the start-up capacitor for delaying firing of the DIAC.

17. The fluorescent lamp of claim 5, wherein the variable-inductor controller comprises:
a voltage divider circuit electrically connected between a power supply node and a ground node for powering the variable-inductor controller;
a first capacitor electrically connected in parallel with the voltage divider circuit for filtering noise;
an initial state module comprising an input terminal electrically connected to an output node of the voltage divider circuit, and an output terminal;
a power and interrupt detector comprising an input terminal electrically connected to the output node of the voltage divider circuit, and an output terminal;
a state machine comprising:
a first input terminal electrically connected to the output terminal of the initial state module;
a second input terminal electrically connected to the output terminal of the power and interrupt detector; and
an output terminal;
a subtractive-capacitor electrically connected in series with the fluorescent tube for providing ballast inductance tuning for fluorescent lamp power adjustment; and
a TRIAC electrically connected in parallel with the subtractive-capacitor for selectively shorting out the subtractive-capacitor, wherein a gate terminal of the TRIAC is electrically connected to the output terminal of the state machine; and
a shunt control electrically connected to the junction of the output terminal of the state machine and the gate terminal of the TRIAC.

18. The fluorescent lamp of claim 17, wherein the signal is fed by a resistor having one end electrically connected to the transformer.

19. The fluorescent lamp of claim 17, wherein the TRIAC is triggered by a signal from a transformer of the generic electronic ballast through a shunt control of the state machine.

20. The fluorescent lamp of claim 19, wherein the shunt control comprises an isolated NMOS and an NMOS in cascode with the gates tied together to exhibit two, or more with additional isolated NMOS, stacked body diodes in the off state.

21. The fluorescent lamp of claim 20, wherein the signal is bypassed to the MT1 of the TRIAC when the cascaded NMOS shunt switch is in the on state.

22. The fluorescent lamp of claim 20, wherein two-quadrant trigger signal is maintained when the cascoded NMOS shunt switch is in the off state.

23. The fluorescent lamp of claim 17, wherein a fourth winding of a transformer of the generic electronic ballast is electrically connected in series with the TRIAC, and polarity of the fourth winding is out of phase with polarity of a first winding of the transformer for additional power attenuation in low-power operation.

24. The fluorescent lamp of claim 17, wherein a fourth winding of a transformer of the generic electronic ballast is electrically connected in series with the tuning capacitor, and polarity of the fourth winding is in phase with polarity of a first winding of the transformer for additional power enhancement in high-power operation.

25. The fluorescent lamp of claim 17, wherein the power supply node is an ac mains node having zero floor voltage after the lamp is powered down for helping signal detection.

26. The fluorescent lamp of claim 25, further comprising a resistor electrically connected between the voltage divider circuit and another ac mains node for providing full-rectified mains voltage to suppress mains ripple voltage.

27. The fluorescent lamp of claim 17, wherein the generic ballast comprises a start-up circuit comprising:
a start-up resistor electrically connected to the power supply node;
a start-up capacitor electrically connected between the start-up resistor and the ground node; and
a DIAC electrically connected to a junction of the start-up resistor and the start-up capacitor;
wherein the power supply node outputs half-rectified mains voltage for increasing charge time of the start-up resistor and the start-up capacitor for delaying firing of the DIAC.

28. The fluorescent lamp of claim 1, wherein the fluorescent tube is terminated to a power supply node, and a generic electronic ballast of the fluorescent lamp comprises a resistor electrically connected between a winding of a transformer of the generic electronic ballast and a ground node for ensuring the variable-inductor controller is powered up from a floating state before a DIAC of the generic electronic ballast fires up the generic electronic ballast.

29. The fluorescent lamp of claim 28, wherein the ground node is an ac mains node having zero floor voltage after the lamp is powered down for helping signal detection.

30. The fluorescent lamp of claim 29, further comprising a second resistor electrically connected between one end of the first resistor and another ac mains node for providing full-rectified mains voltage to suppress mains ripple voltage.

31. The fluorescent lamp of claim 1, wherein the fluorescent tube is terminated to a center tap of two series connected capacitors between a ground node and a power supply node, and a generic electronic ballast of the fluorescent lamp comprises a resistor electrically connected between a winding of a transformer of the generic electronic ballast and the ground node for ensuring the variable-inductor controller is powered up from a floating state before a DIAC of the generic electronic ballast fires up the generic electronic ballast.

32. The fluorescent lamp of claim 31, wherein the ground node is an ac mains node having zero floor voltage after the lamp is powered down for helping signal detection.

33. The fluorescent lamp of claim 32, further comprising a second resistor electrically connected between one end of the first resistor and another ac mains node for providing full-rectified mains voltage to suppress mains ripple voltage.

34. A variable-inductor for use in a fluorescent lamp, the variable-inductor comprising:
an inductance tuning module; and
a switching module for selectively enabling series electrical connection between the inductance tuning module and a fluorescent tube of the fluorescent lamp for providing ballast inductance tuning for fluorescent lamp power adjustment.

35. The variable-inductor of claim 34, wherein the inductance tuning module is a subtractive capacitor.

36. The variable-inductor of claim 34, wherein the inductance tuning module is an additive inductor.

37. The variable-inductor of claim 34, wherein the switching module is a TRIAC for auto-switching.

38. The variable-inductor of claim 37, wherein the TRIAC is coupled to a transformer that drives transistor switches of a half-bridge inverter of the fluorescent lamp.

39. The variable-inductor of claim 37, wherein a control signal for controlling the TRIAC is coupled to a power and interrupt detector for sequential dimming.

40. The variable-inductor of claim 37, wherein a control signal for controlling the TRIAC is coupled to an occupancy detector for energy savings dimming.

41. The variable-inductor of claim 37, wherein a control signal for controlling the TRIAC is coupled to a photo detector for ambient light compensation.

42. The variable-inductor of claim 34, wherein the switching module is a mechanical switch for manual switching.

43. The variable-inductor of claim 34, further comprising a transformer winding electrically connected to the inductance tuning module, wherein the transformer winding has polarity oriented for decreasing core saturation of a transformer of the fluorescent lamp when fluorescent lamp power is decreased by enabling the series electrical connection between the inductance tuning module and the fluorescent tube.

44. The variable-inductor of claim 34, further comprising a transformer winding electrically connected to the inductance tuning module, wherein the transformer winding has polarity oriented for increasing core saturation of a transformer of the fluorescent lamp when fluorescent lamp power is increased by enabling the series electrical connection between the inductance tuning module and the fluorescent tube.
